(19) United States
(12) Patent Application Publication
(10) Pub. No.: US 2009/0319626 A1
(43) Pub. Date: Dec. 24, 2009

(54) Method for networking a plurality of convergent messaging systems and corresponding network system

(76) Inventor: Matthias Röbke, Koln (DE)

Correspondence Address: SHLESINGER, ARKWRIGHT & GARVEY LLP, 1420 KING STREET, SUITE 600, ALEXANDRIA, VA, 22314, US

(21) Appl. No.: 12/311,290

(22) PCT Filed: Sep. 27, 2007
(86) PCT No.: PCT/EP2007/008402

§ 371 Date: Mar. 25, 2009

(30) Foreign Application Priority Data
Sep. 27, 2006 (DE) 10 2006 047 112.1

(51) Int. Cl. G06F 15/16; G06F 15/173

(52) U.S. Cl. 709/206; 709/238

(57) ABSTRACT

The present invention relates to a method for networking a plurality of providers (KMS1, . . . , KMS n) of a convergent messaging service in a network system (1), wherein at least one central broker function unit (broker 1, . . . broker m) is provided, which is physically connected between the individual providers (KMS1, . . . , KMS n) and during the transport of a message to be executed between the providers (KMS1, KMS n) assumes a central routing function within the network system (1). The present invention also provides a suitable network system.

The present invention relates to a method for networking a plurality of providers of a convergent messaging service in a network system. In addition the present invention relates to a corresponding network system comprising a networking of a plurality of providers of a convergent messaging service. The present invention also relates to a computer program and a computer program product.

### BACKGROUND OF THE INVENTION

Nowadays various so-called messaging services are known in mobile phone technology. Within the context of the present invention a messaging service should be understood as any type of information and messaging service that is available or that can be made available in mobile phone technology. Such services include for example SMS (Short Messaging Service), MMS (Multimedia Messaging Service), EMS (Enhanced Messaging Service), IM (Instant Messaging), PTT (Push-To-Talk) service. These various services are currently designed and set up as individual so-called silos. This means that each of these services exists quasi independently of the respective other service. This currently prevailing silo approach will be replaced in the foreseeable future by a so-called “convergent messaging” approach. Convergence is understood in this connection to mean a bringing together of the various messaging services and thus of the possibly different transmission techniques associated therewith.

This may possibly include an integration of various communication services, such as for example data communications, with telecommunication services, such as mobile communications, an integration of transmission techniques and of media contents, so that for example graphics, audio, text and video can be transmitted via identical media. Such a replacement of existing messaging services means however that each service provider creates its own “convergent messaging” environment. However, in order to be able to respond to the largest possible number of customers the thereby formed convergent messaging systems of each service provider must be able to communicate with one another.

Since such a scenario has still not been realised up to now, there is also no possibility of networking an extremely simple and efficient communication between “convergent messaging” environments of different service providers with one another in order to achieve a good communication between these providers. An object of the present invention was accordingly to provide a method for realising an efficient networking of the various service providers of a “convergent messaging service”. A further object of the present invention was to propose a corresponding network system with an efficient networking of such service providers.

### SUMMARY OF THE INVENTION

The aforementioned object is achieved by a method with the features of claim 1 and a network system with the features of claim 9. The respective dependent claims describe advantageous embodiments.

According to claim 1 a method is provided for networking a plurality of providers of a convergent messaging service in a network system. For this, at least one central broker function unit is provided, which is physically connected between the individual providers and during the transport of a message to be effected between the providers assumes a central routing function within the network system. The aforementioned convergent messaging service includes, as already mentioned above, any type of information and messaging service that is available or can be made available in mobile phone technology. This means, in the words of the description of the prior art, that we are dealing here with a “messaging service”. The central broker function unit is, in accordance with a terminology employed in mobile phone technology, a central broker. The central broker function unit, which is connected between the individual providers, acts as a routing function unit between the individual service providers and their respective convergent messaging systems. A router is generally understood to denote a switching (broking) site in a network system, through which data packets are transferred from one network to another network. The network system, such as for example the internet, functions in this case as a group or set of individual networks that for example are connected to one another via such a router. In the present case the broker serves as a routing function that connects the individual providers of the convergent messaging service and their convergent messaging systems and environments associated therewith, to one another. Now, with the aid of the broker or the broker function unit, not every individual provider of a convergent messaging service or the convergent messaging system associated therewith has to interact with all other providers, but can communicate centrally with the broker function unit and/or with the broker. The broker function unit, which is physically connected to a plurality of service providers, thus assumes during a transport of a message between the providers the task of transporting the corresponding message to a respective target provider.

This means that, in accordance with an embodiment of the method according to the invention, the at least one central broker function unit acts during the transport of a message from a first provider to a second provider as addressee of the message to be transported with respect to the first provider and as sender of the message to be transported with respect to the second provider, whereby a 1:n relationship is realised between the broker function unit and the respective providers. Thus, in a convergent “messaging” or message context it is not necessary to realise 1:1 relationships between the service providers, but simply to realise a 1:n relationship between the respective service provider and the broker function unit, so as to permit an interworking with a plurality of other providers.

It is conceivable that the convergent messaging service brings together at least services from the group consisting of SMS, MMS, IM, EMS and Push-To-Talk.

It is furthermore conceivable in the method according to the invention to provide a plurality of broker function units in the network system, which in each case are indirectly or directly connected between the providers.

In this connection it is possible that the plurality of broker function units are at least partly connected in series. In this way it is possible that a plurality of broker function units or brokers are involved in the transport of a message that is to be sent from a provider to a target provider.

According to a further embodiment of the method according to the invention, for the transmission of messages a transport protocol is provided and employed, which is designed in such a way as to use the at least one broker function unit both as addressee and as sender. This means that an address is associated with the at least one broker function unit. In the case where a plurality of broker function units exists a respective address must correspondingly be associated with each of the broker function units.

It is furthermore conceivable to provide mechanisms by means of which the address of the at least one broker function unit interconnected in the transport of a message is made available to each provider acting as target provider in the transport of the message, for the purposes of addressing at least one possible response message. Furthermore it is also possible that in the case where multiple broker function units exist that are possibly involved in the transport of a message between a provider and a target provider, all addresses of the involved broker function units are known or are made available to the target provider, so that the target provider is capable of addressing possible response messages also directly to each of the broker function units, which in turn can pass on this response message to the corresponding sender or output provider.

The present invention also relates to a network system involving a networking of a plurality of providers of a convergent messaging service. In this connection the networking of the plurality of providers of a convergent messaging service takes place in conjunction with a networking of a number of convergent messaging service systems and environments corresponding to the number of providers. In this case, in accordance with the invention at least one central broker function is provided in the network system, which is physically connected between the individual providers and their correspondingly associated environments, respectively, and which during the transport of a message to be executed between the providers assumes a central routing function within the network system.

It is conceivable that the at least one central broker function unit, also termed a broker in the context of the invention, acts during the transport of a message from a first provider to a second provider as addressee of the message to be transported in respect to the first provider and as sender of the message to be transported in respect to the second provider, whereby a 1:n relationship is realised between the broker function unit and the respective providers. This means that, as already mentioned, in a convergent messaging context it is not absolutely necessary to realise a 1:1 relationship between various service providers, but simply to provide a 1:n relationship between a respective service provider and the broker function unit, in order to be able to achieve an interworking with a plurality of other providers.

The convergent messaging service can in this connection bring together at least services from the group consisting of SMS, MMS, IM, EMS and Push-To-Talk.

It is conceivable to provide a plurality of broker function units in the network system, which in each case are connected directly or indirectly between the individual providers. In this case it is conceivable that at least some of the broker function units are connected in series, so that for example a plurality of broker function units are involved in the transport of a message between a first provider and a second provider.

For message transmission there is provided in the network system a transport protocol that is designed in such a way as to use the at least one broker function unit both as addressee and as sender. In the case where a plurality of broker function units is provided in the network system, then all broker function units involved in the network system should be able to be used both as addressee and as sender. In this connection it should be possible to associate an address with each of the broker function units that is provided in the network system and which can be involved in the transport of a message between providers of a convergent messaging service. In this way it is possible for a provider that accesses a message of another provider to address, for the purposes of addressing a response message, one of the broker function units that was involved in the transport of the originally sent message.

In addition the present invention provides a computer program with program coding means, with the aid of which all steps of a method according to the invention can be carried out when the computer program is run on a computer or a corresponding computing unit, preferably within the network system.

The present invention furthermore provides a computer program product with a computer program with program coding means stored on a computer-readable medium, with the aid of which all steps of a method according to the invention can be carried out when the computer program is run on a computer or a corresponding computing unit, preferably within the network system.

Further advantages and modifications of the invention follow from the description and the accompanying drawing.

It is understood that the features mentioned hereinbefore and to be discussed further hereinafter can be used not only in the combination specified in each case, but also in other combinations or in isolation, without going beyond the scope of the present invention.

### BRIEF DESCRIPTION OF THE DRAWING

The invention is diagrammatically illustrated in the drawing with the aid of an embodiment and is described in detail hereinafter with reference to the said drawing.

FIG. 1 shows diagrammatically one embodiment of a network system according to the invention, in which a plurality of providers of a convergent messaging service are networked with one another.

### DETAILED DESCRIPTION OF THE DRAWING

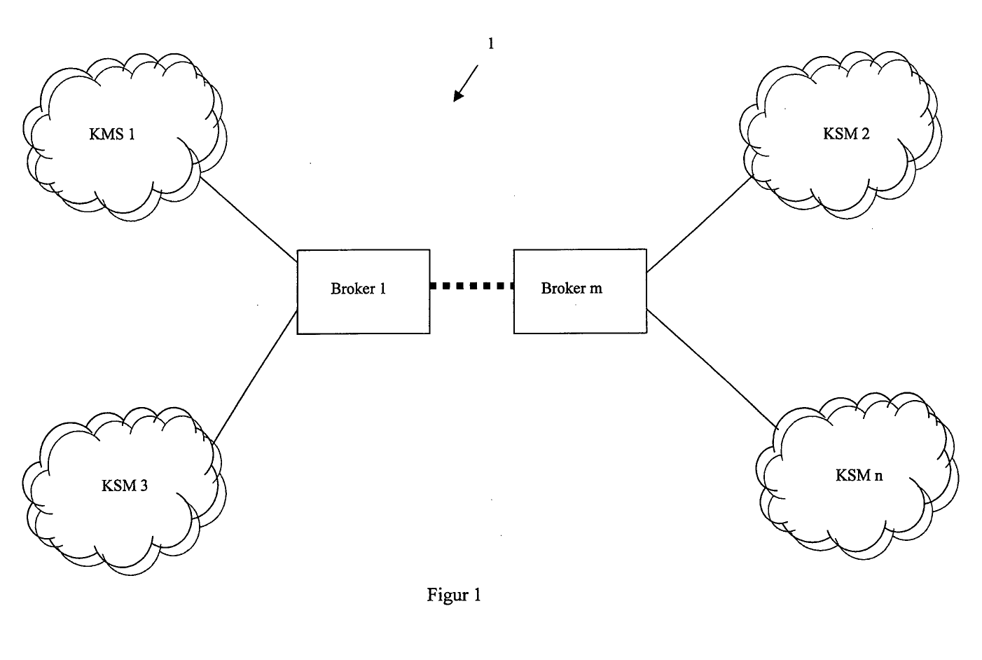

FIG. 1 shows a diagrammatic representation of a network system 1. Within the network system 1 are provided a plurality of providers of a convergent messaging service KMS 1, . . . , KMS n. Between the individual providers and between their convergent messaging environments, respectively, KMS 1, . . . , KMS n associated with them in each case, which are shown here in the form of a respective cloud, is arranged in each case at least one central broker function unit identified here as broker. Between the service provider KMS 1 and the service provider KMS 3 there is, thereby, arranged a broker function unit broker 1, which during the transport of a message to be executed between the provider KMS 1 and the provider KMS 3 assumes a central routing function within the network system 1. If however a message is to be transported between KMS 1 and KMS 2, then this message is transmitted via a plurality of interconnected broker function units broker 1, . . . , broker m. This means that here a plurality of broker function units are connected in series, and all are together involved in the transmission of a message between KMS 1 and KMS 2. The same also applies to the transmission of a message between KMS 1 and KMS n or between KMS 3 and KMS 2 as well as between KMS 3 and KMS n. During the transmission of a message between KMS 2 and KMS n again only a broker m is interconnected, which during the transmission of a message to be executed between KMS 2 and KMS n assumes a routing function within the network system 1. Irrespective of how many broker function units are arranged between the providers between which the transmission of a message is to take place, each of the plurality of providers is nevertheless directly connected to only just one broker or one broker function unit, so that each of the providers has to address its message to only just one broker function unit. This greatly facilitates the addressing on the part of the providers and thus the transmission of messages to a plurality of other providers, since instead of a plurality of addressings only one addressing, namely that to the broker function unit directly connected to the corresponding provider, is necessary. Each of the broker function units can in turn be directly connected to a plurality of providers, thereby resulting in a 1:n relationship as regards broker function unit and service providers. A broker function unit can, furthermore, as is shown in FIG. 1, be connected to a further broker function unit, to which possibly a message is transmitted, before it is passed on further by the associated broker function unit to a target provider. The number of broker function units that can be connected in series or to one another is arbitrary and depends inter alia on the size of the network system and the number of providers present in the network system and on the convergent messaging environments associated therewith. This means that the number m specified here can adopt any arbitrary natural number greater than zero. The same is also true for the number n which indicates here the number of providers.

1-18. (canceled)

19. Method for networking a plurality of providers (KMS1, . . . , KMS n) of a convergent messaging service in a network system, wherein a plurality of broker function units (broker 1, broker m) are provided, which are physically connected between the individual providers (KMS1, . . . , KMS n) and during the transport of a message to be executed between the providers (KMS1, . . . KMS n) assume a central routing function within the network system, wherein the plurality of broker function units (broker 1, . . . broker m) are at least in part connected in series.

20. Method according to claim 19, in which at least one central broker function unit (broker 1, . . . , broker m) during the transport of a message from a first provider to a second provider acts as addressee of the message to be transported with respect to the first provider and as sender of the message to be transported with respect to the second provider, whereby a 1:n relationship is realized between the broker function unit and the respective providers.

21. Method according to claim 19, in which the convergent messaging service brings together at least services from the group consisting of SMS, MMS, IM, EMS, Push-To-Talk.

22. Method according to claim 19, in which the broker function units (broker 1, . . . , broker m) in the network system are in each case connected directly or indirectly between the providers (broker 1, . . . , broker m).

23. Method according to claim 19, in which for the transmission of a message a transport protocol is employed which is designed in such a way as to use a respective broker function unit (broker 1, . . . broker m) both as addressee as well as sender.

24. Method according to claim 19, in which an address is associated with at least one broker function unit (broker 1, . . . , broker m).

25. Method according to claim 24, in which the address of the at least one broker function unit (broker 1, . . . , broker m) interconnected during the transport of a message is made available to each provider acting as target provider during the transport of the message, for the purposes of addressing at least one possible response message.

26. Network system with a networking of a plurality of providers (KMS1, . . . , KMS n) of a convergent messaging service, wherein in the network system a plurality of broker function units (broker 1, . . . , broker m) are provided, which are physically connected between the individual providers (KMS1, . . . , KMS n) and during the transport of a message to be executed between the providers (KMS1, . . . , KMS n) assume a central routing function within the network system, wherein the plurality of broker function units (broker 1, . . . , broker m) are connected at least in part in series.

27. Network system according to claim 26, in which at least one central broker function unit (broker 1, . . . , broker m) during the transport of a message from a first provider to a second provider acts as addressee of the message to be transported with respect to the first provider and as sender of the message to be transported with respect to the second provider, whereby a 1:n relationship is realized between the broker function unit and the respective providers.

28. Network system according to claim 26, in which the convergent messaging service collects together services from the group consisting of SMS, MMS, IM, EMS, Push-To-Talk.

29. Network system according to claim 26, in which a plurality of broker function units (broker 1, . . . , broker m) are provided in the network system, which are in each case connected directly or indirectly between the providers (KMS 1, . . . , KMS n).

30. Network system according to claim 26, in which for the transmission of a message a transport protocol is provided that is designed so as to use a respective broker function unit both as addressee as well as sender.

31. Network system according to claims 26, in which an address is associated with at least one broker function unit.

32. Network system according to claim 31, in which the address of the at least one broker function unit interconnected during the transport of a message can be made available to each provider acting as target provider during the transport of a message, for the purposes of addressing at least one possible response message.

33. Computer program with program code means, which are suitable for executing all steps of a method according to claim 19 when a computer program is run on a computer or a corresponding computing unit.

34. Computer program product with a computer-readable medium and a computer program with program code means stored on the computer-readable medium, which are suitable for executing all steps of a method according to claim 19 when the computer program is run on a computer or a corresponding computing unit.
